(19) United States
(12) Patent Application Publication
(10) Pub. No.: US 2004/0095589 A1
(43) Pub. Date: May 20, 2004

(54) Image processing method

(76) Inventor: Tsunekazu Arai, Tokyo (JP)

Correspondence Address: Joseph A. Calvaruso, Esq., Morgan & Finnegan, L.L.P., 345 Park Avenue, New York, NY, 10154-0053, US

(21) Appl. No.: 10/703,791

(22) Filed: Nov. 6, 2003

(30) Foreign Application Priority Data
Nov. 12, 2002 (JP) 2002-328519

(51) Int. Cl. G06F 15/00; H04N 1/46

(52) U.S. Cl. 358/1.2; 358/1.13; 358/528

(57) ABSTRACT

To develop a vector image to bitmap data having a designated output size and output the bitmap data, developing unit converts the stored rendering data to a designated output size in accordance with reduction designation of the vector image.

### FIELD OF THE INVENTION

The present invention relates to a technique of developing a vector image to rendering data having a designated output size and outputting the rendering data.

### BACKGROUND OF THE INVENTION

Conventional rendering apparatuses for developing a vector image to rendering data, such as bitmap data, are purposed for accurate printing at high resolution. An example of this case is a laser printer which interprets page code data written in a page description language (PDL), such as widely used PostScript, and prints images at high resolution. In such apparatuses, even in a case where a user's designation to output an image results in an extremely small-size image, data that will represent the described vector image is calculated in accordance with the output size, and bitmap data is developed and outputted as a print image.

Generally, a font rasterizer capable of processing vector fonts uses bitmap fonts when it is designated to output a small-size font, and uses vector fonts when it is designated to output a large-size font. Therefore, the bitmap fonts used in small sizes need to be generated in advance as separate data. When a vector font is developed to bitmap data having a certain size, it is a well-known technique to store the developed bitmap data in a cache memory or the like for reusing the bitmap data.

However, developing a vector image to a bitmap image requires certain calculation time. Particularly if a small area of the image includes a lot of complicated curved lines, the amount of calculation cannot be disregarded. In the meantime, in a case of outputting such image at low resolution or in a small size, the complicated part of the image is not shown on the output image, only generating a subtle difference that may be overlooked.

As is realized in a general rasterizer capable of processing vector fonts, the problem of calculation time can be solved by preparing small sizes of fonts in advance. However, unlike the fonts whose shapes of the image are predetermined, vector images have indefinite shapes. Therefore, preparing vector images in advance is not realistic if the memory capacity is taken into consideration.

Furthermore, it may be possible to store all vector images in a cache memory or the like at the time of developing the vector images so that the images can be reused. However, it raises a problem of quickly running out of the cache memory capacity.

But for a simple square or circle, the amount of calculation for developing the image to bitmap data is not that much to be concerned.

### SUMMARY OF THE INVENTION

The present invention has been proposed to solve the above-described problems, and has as its feature to render vector images at high speed.

To solve the problems, one aspect of the present invention provides an image processing method for developing a vector image to rendering data having a size, comprising: a step of developing a vector image to rendering data; a step of storing the rendering data, developed in the developing step, in accordance with a predetermined criterion; and a step of converting the rendering data, stored in the storing step, to rendering data having a designated output size in accordance with reduction designation of the vector image.

Furthermore, according to another aspect of the present invention, the present invention provides an image processing apparatus for developing a vector image to rendering data having a designated output size and outputting the rendering data, comprising: a developing unit for developing a vector image to rendering data; a storage unit for storing the rendering data, developed by the developing means, in accordance with a predetermined criterion; and wherein the developing unit converts the stored rendering data to a designated output size in accordance with reduction designation of the vector image.

Furthermore, according to another aspect of the present invention, the present invention provides an image processing apparatus for developing a vector image to rendering data having a designated output size and outputting the rendering data, comprising: developing means for developing a vector image to rendering data; storage means for storing the rendering data, developed by the developing means, in accordance with a predetermined criterion; and converting means for converting the stored rendering data to a designated output size in accordance with reduction designation of the vector image.

Other features and advantages of the present invention will be apparent from the following descriptions taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 shows a usage pattern of a portable information technology device according to an embodiment of the present invention;

FIG. 2 is a block diagram showing a brief construction of the portable information technology device shown in FIG. 1;

FIG. 3 shows a flow of the process according to the embodiment of the present invention;

FIG. 4 shows an example of a simple object of vector graphic data;

FIG. 5 shows an example of a complicated object of vector graphic data;

FIG. 6 is a flowchart showing a SVG data developing process according to the present embodiment;

FIG. 7 is a flowchart showing a SVG data development switching process;

FIG. 8 shows a flow of the process according to a modified example of the present invention;

FIG. 9 is a flowchart showing a SVG data developing process according to the modified example; and

FIG. 10 is a flowchart showing a calculation process of predicted bitmap conversion time.

### DETAILED DESCRIPTION OF THE PREFERRED EMBODIMENT

A preferred embodiment of the present invention will now be described in detail in accordance with the accompanying drawings. This embodiment describes processes that enable high-speed rendering of vector images at low resolution in portable information technology devices, e.g., mobile phones, personal digital assistants (PDA) and so on.

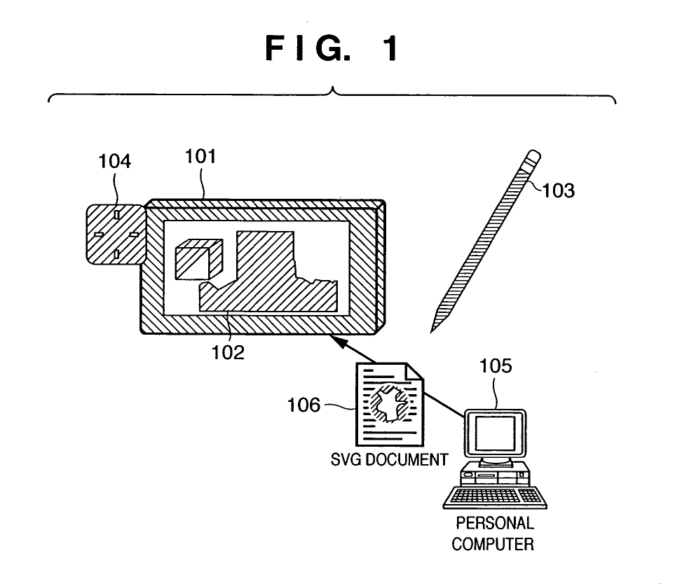

FIG. 1 shows a usage pattern of a portable information technology device according to this embodiment. In FIG. 1, a portable information technology device 101 comprises: a camera unit 104, a liquid crystal display unit 102, a coordinate input unit 201 formed with resistant film or the like, a CPU 205, ROM 207, RAM 206, a recording medium I/F 208 for inserting a recording medium, and a communication I/F 210, such as a USB, for connecting other information technology devices. An image sensed by the camera unit 104 can be displayed on the liquid crystal display unit 102, and a memo to be added to the image can be generated on the basis of stroke data inputted from the coordinate input unit 201. The ROM 207 stores a data processing procedure of the portable information technology device, which is the present embodiment. The RAM 206 stores scalable graphic data, e.g., scalable vector graphics (SVG) transmitted from an external apparatus, photographic image data sensed by the camera unit 104, stroke data inputted from the coordinate input unit 201, and so on.

Inputted handwriting stroke data is stored as it is and attached to an image as a memo, or converted to text data by processing of the CPU 205. Such image data accompanied by the memo is transmitted to a personal computer through the USB interface in accordance with user's designation. Alternatively, the image data is transmitted to a personal computer or a printer via a user medium. (e.g., a memory card).

The liquid crystal display unit 102 is provided with a widely used transparent resistant film digitizer for performing coordinate input on the monitor of the liquid crystal display as the coordinate input unit 201. A user can input a handwriting stroke by pressing the liquid crystal display monitor with a pen 103. A display processing program for bitmapping the SVG graphic data stored in the RAM and displaying the bitmap data in the liquid crystal display unit 102 is stored in the ROM of the portable information technology device 101.

The pen 103 is used for inputting handwriting stroke data, or for pressing a soft button or soft keyboard on a display monitor. The camera unit 104 comprises a lens and an image sensing device, e.g., a CCD. The camera unit 104 is controlled by the CPU 205 of the portable information technology device 101. Image data sensed by the camera unit 104 is stored in the RAM 206 through the bus connected with the CPU 205. Images sensed by the camera unit 104 can be attached to an electronic mail to be transmitted.

A personal computer 105 can be connected to the portable information technology device 101 through a universal serial bus (USB), IEEE1394, a local network, a public network, or a wireless interface unit such as IrDA or Bluetooth, or a server computer. The personal computer 105 transmits scalable graphic data, e.g., SVG, to the portable information technology device 101.

A SVG document 106 is a conceptualized document file generated with the scalable graphic data, e.g., SVG. The document is generated by being converted from a typical word-processor document, presentation document or the like by a program stored in the personal computer 105.

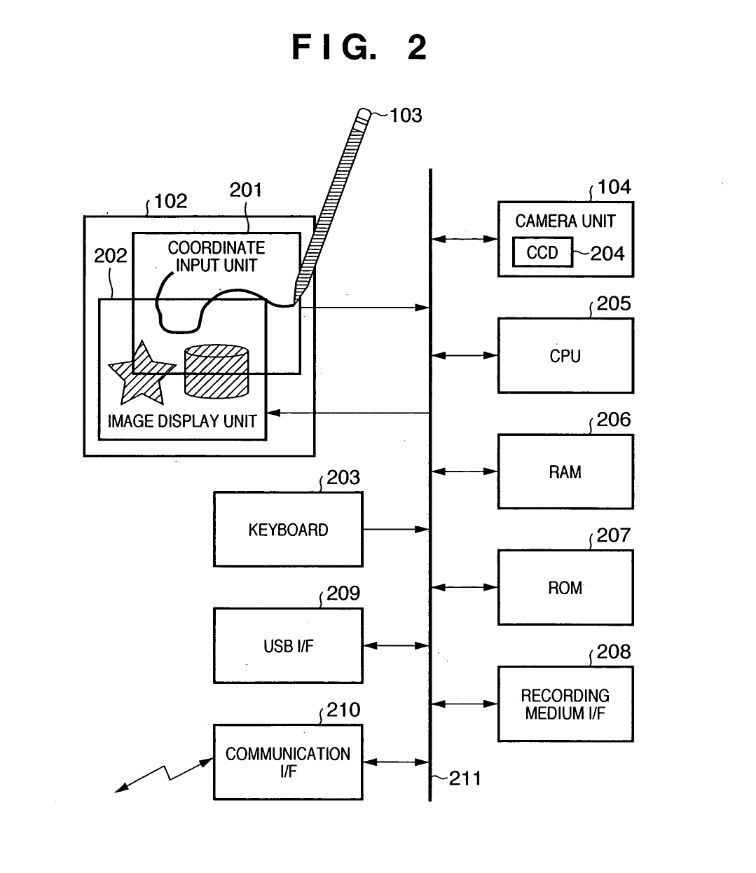

FIG. 2 is a block diagram showing a brief construction of the portable information technology device shown in FIG. 1. In FIG. 2, the position coordinate input unit 201 is configured with a resistant film digitizer arranged on the top surface of the image display area 202. The resistant film digitizer is connected via a control circuit to the CPU 205 through a system bus 211. When a user depresses the monitor with a pen 103 as mentioned above, the CPU 205 reads position coordinate data of the depressed position. Based on the read position coordinate data, display processing of the SVG graphic data is performed in accordance with the processing procedure of a program read out of the ROM 207.

The image display unit 202 is constructed with a liquid crystal display device, a liquid crystal controller, and display memory. The image display unit 202 is connected to the CPU 205 through the system bus 211. In accordance with a designation from the CPU 205, image data or handwriting stroke data is displayed on the monitor.

Numeral 203 denotes a widely used keyboard. By depressing a key, key codes such as alphabets or numbers are inputted, and the inputted key codes are read by the CPU 205.

An image sensing device 204 of the camera unit 104 is configured with a CCD or the like. Besides the image sensing device 204, the camera unit 104 comprises a lens (not shown), a CCD controller and so forth. The CCD controller is connected to the CPU 205 through the system bus 211. In other words, the CCD 204 is controlled by the CPU 205. Sensed images are stored in the RAM 206.

The CPU 205 is connected to the RAM 206, ROM 207, position coordinate input unit 201, and image display area 202 through the system bus 211. The CPU 205 performs processing by reading a program stored in the ROM 207.

The RAM 206 is used for storing SVG image data, or used as a working area of a program or a temporary storage area of bitmap data.

The ROM 207 stores a SVG graphic data display control program according to this embodiment. The ROM 207 also stores a program for the CCD controller, a control program of the image display unit 102, a handwriting stroke recognition program, a process procedure such as handwriting stroke shape dictionary data, and so forth.

The recording medium I/F 208 is an interface unit for inserting a recording medium which records images, e.g., a compact flash (registered trademark) card, and realizes data reading and writing from/to the inserted card. Image data can also be written in the card.

The USB interface unit 209, which is controlled by the CPU 205, is connected to the personal computer 105 to exchange handwriting stroke data, SVG image data and so forth.

The communication I/F 210 incorporates a connection controller and antenna to be connected to a PHS (personal handyphone system) line. Sending a set command to the controller of the communication I/F 210 realizes connection to a public network and transmission/reception of an electronic mail. By substituting the communication I/F 210 with a local area network card, the information technology device 101 can be adapted to a local area network. Note, for transmitting and receiving electronic mail, the conventional protocol can be used.

The system bus 211 is provided for data exchange among the CPU 205, RAM 206, ROM 207 and other devices.

With respect to the above-described construction, a description is now provided on the processing in a case where it is designated to display a SVG image data file, stored in the RAM 206 in FIG. 2, on the image display area 202. The actual processing procedure is stored as a program in the ROM 207 in FIG. 2. The display designation is realized by a conventional designation method (e.g., an icon on the monitor representing the target file is double-tapped with a pen, thereby displaying contents of the file on the monitor). Designation of a display size of the image is also realized by a widely used zoom designation method, e.g., 100% display, 20% display or the like.

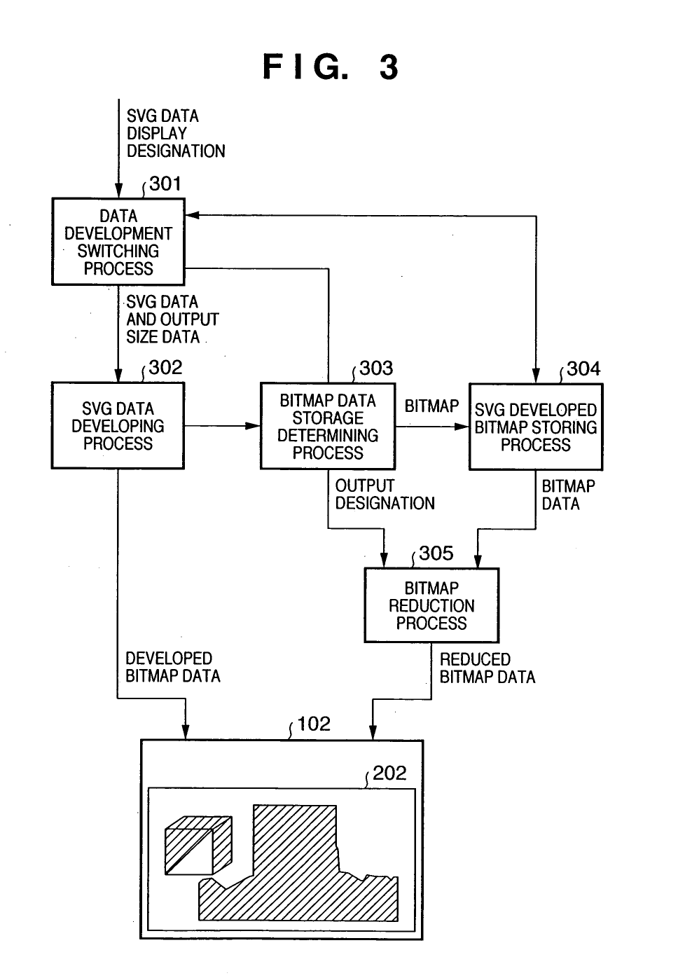

FIG. 3 shows a flow of the rendering process according to the present embodiment. The processing is executed by the CPU 205 based on a program read out of the ROM 207. Referring to FIG. 3, in a data development switching process 301, an SVG image data file and numeral data of an output size of the image to be displayed are inputted. If a large size, e.g., 100%, is designated as an output size, the SVG image data file is transferred to a SVG data developing process 302. If a small size, e.g., 20%, is designated as an output size, the data file is checked in units of displaying object.

If developed bitmap data of the displaying object which is being checked has already been stored in the SVG developed bitmap storing process 304, the stored bitmap data is transferred to a bitmap reduction process 305 along with a designation to display the object. However, if developed bitmap data of the displaying object which is being checked has not been stored in the SVG developed bitmap storing process 304, a designation to display the object is sent to an SVG data developing process 302.

In the SVG data developing process 302, the vector graphic data in units of displaying object, which is processed in the data development switching process 301, is developed to bitmap data. For instance, bitmap data is generated from vector graphic data in the similar manner to the processing of a conventional rasterizer capable of processing vector fonts. The generated bitmap data is displayed in the image display area 202. The bitmap data generated in the SVG data developing process 302 and the vector graphic data for each of the displaying object are transferred to a bitmap data storage determining process 303.

In the bitmap data storage determining process 303, a complication level of the SVG vector graphic data, which is processed in the SVG data developing process 302, is determined. When it is determined that calculation for developing the vector graphic data takes longer time than a predetermined value, the developed bitmap data is stored in the SVG developed bitmap storing process 304. In a case of simple vector graphic data, the data is not stored.

In the SVG developed bitmap storing process 304, the vector graphic data and the developed bitmap data transmitted from the bitmap data storage determining process 303 are stored. Herein, the vector graphic data and the developed bitmap data are stored in pairs. Since the developed bitmap data is used when it is displayed as a reduced image, losing its accuracy does not cause problems. Therefore, the bitmap data is stored using a widely used JPEG compression method. To retrieve developed bitmap data in the data development switching process 301, an object of the target vector graphic data is searched.

In the bitmap reduction process 305, the developed bitmap data, stored in the SVG developed bitmap storing process 304, is reduced to a designated output size and outputted. The reduction of the bitmap data may be realized by a conventional method. The reduced bitmap data is displayed in the image display area 202.

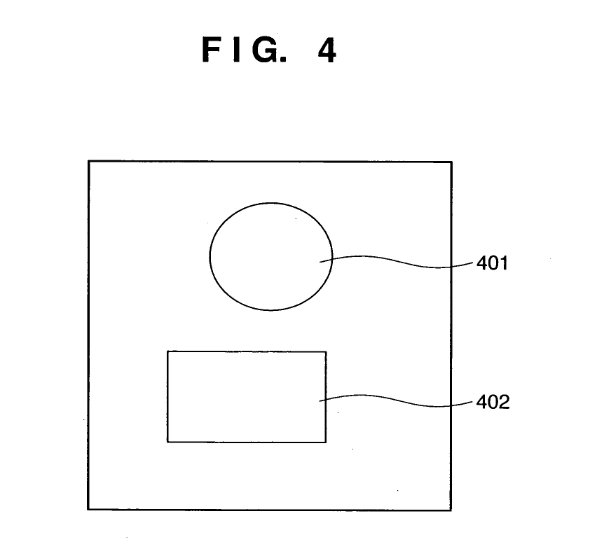

FIG. 4 shows an example of a simple object of vector graphic data. In FIG. 4, numeral 401 denotes a circle as an object example, and 402 denotes a rectangle as an object example. In reality, the vector graphic data, e.g., rectangle 402 shown in FIG. 4, is described as follows. In the following example, x and y represent coordinate values. In accordance with the coordinate values, straight lines are drawn to render a rectangle.

x1 y1 moveto

x2 y1 lineto

x2 y2 lineto

x3 y2 lineto

stroke

The circle 401 in FIG. 4 is described as follows, using coordinate values representing the center of the circle, a radius, a starting angle of the arc, an ending angle of the arc, and a type of command of the arc.

x5 y5 r angle1 angle2 Arc

stroke

The type of command includes “stroke” and “fill.” “Stroke” commands to render a line between coordinate points. “Fill” commands to fill an area surrounded by lines which connect the designated coordinate points. Besides the above, the type of command also includes a setting command of filling patterns, a bitmap rendering command of photographic images, and a rendering timing setting command for animation images. However, since these are not directly related to the present invention, a description thereof is omitted.

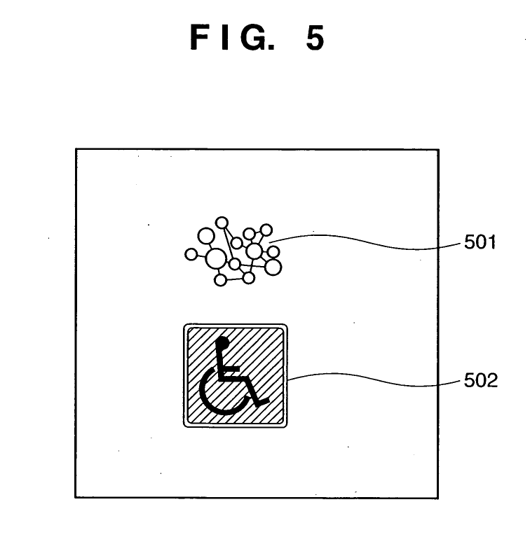

FIG. 5 shows an example of a complicated object of vector graphic data. In FIG. 5, numeral 501 denotes a symbol 1 as an object example, and 502 denotes a symbol 2 as an object example.

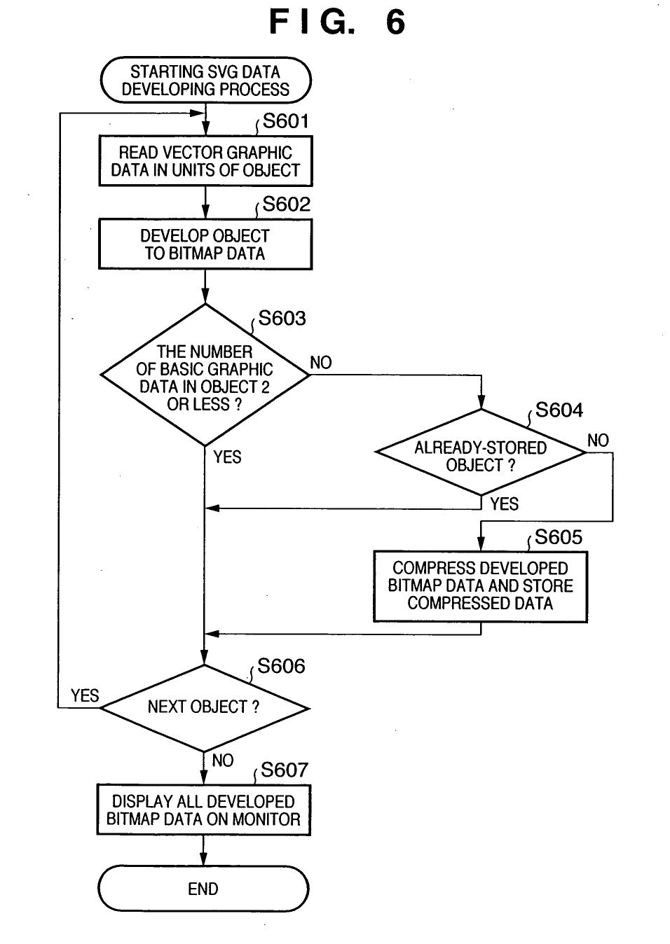

Hereinafter, the SVG data developing process and the SVG data development switching process according to this embodiment are described. First, the SVG data developing process is described with reference to FIG. 6. This process corresponds to the SVG data developing process 302 in FIG. 3. Note that a SVG data file is transmitted from the widely used personal computer 105 or generated by an application program stored in the ROM 207. Since the generation of SVG data file is not directly related to the present embodiment, a description thereof is omitted. In this embodiment, the SVG data file is constructed with a plurality of vector graphic data objects that correspond to one screen page. For instance, FIG. 4 shows an example of one screen page, which is constructed with a circle object and a rectangle object.

FIG. 6 is a flowchart showing a SVG data developing process according to the present embodiment. In step S601, a working area to be used for the SVG data development is initialized, and vector graphic data is read in units of object. In other words, one designated file of the SVG data file is sequentially read from the beginning. Referring to the example shown in FIG. 4, the circle object 401 is first read and stored in the working area. Upon reading the circle object 401, a rectangle object 402 is read and stored in the working area.

In step S602, the read object is developed to a bitmap image. Taking the rectangle 402 shown in FIG. 4 as an example, the vector graphic data is given as follows:

x1 y1 moveto

x2 y1 lineto

x2 y2 lineto

x1 y2 lineto

stroke

The developing process is performed in the following manner. First, data is written in the memory area so as to form a straight line from the memory address of the coordinate (x1, y1) to the memory address of the coordinate (x2, y1) in the virtual screen memory of the RAM 206. Then, data is written in the memory area so as to form a straight line from the memory address of the coordinate (x2, y1) to the memory address of the coordinate (x2, y2). Then, data is written in the memory area so as to form a straight line from the memory address of the coordinate (x2, y2) to the memory address of the coordinate (x1, y2). Then, data is written in the memory area so as to form a straight line from the memory address of the coordinate (x1, y2) to the memory address of the coordinate (x1, y1).

By the foregoing process, the rectangle 402 is developed in the virtual screen memory of the RAM 206. This process is similar to the process performed in conventional laser beam printers (LBP) capable of processing vector graphic data.

In step S603, it is determined whether or not the number of basic graphic data in the object is two or less. This is to determine whether the target object is a simple object or a complicated object. This process corresponds to the bitmap data storage determining process 303 shown in FIG. 3. More specifically, the number of basic graphics in the read object data is counted to make the determination. The unit of basic graphics includes a rectangle, a circle and the like as shown in FIG. 4. Assume that the object is expressed by the following data:

x1 y1 moveto

x2 y1 lineto

x2 y2 lineto

x1 y2 lineto

stroke

x2 y1 r angle1 angle2 Arc

stroke

The number of basic graphics is counted at the following timing:

x1 y2 lineto

stroke

Then, the number is incremented at the following timing:

x2 y1 r angle1 angle2 Arc

stroke

The total number of basic graphics is 2.

In this case, since the number of basic graphic data is 2 or less, the control proceeds to step S606. Taking the object 501 shown in FIG. 5 as an example, since the object 501 is broken down to 13 circles and 16 straight lines, it is determined that the number of basic graphic data does not fall within 2 or less, so the control proceeds to step S604.

Note although the present embodiment determines a complication level by determining whether or not the number of basic graphics in the object is 2 or less, the complication level may be determined by the number of command sets representing setting of the most basic coordinate point. In this case, the complication level of the line setting command “x2 y1 lineto” is 0.2, and the complication level of the arc rendering command “x2 y1 r angle1 angle2 Arc” is 0.8. The complication level may be set with an addition of calculation time required for performing the rendering process executed by the command.

A threshold value for the determination criteria of the complication level should be changed in accordance with the calculation speed of a CPU installed in the apparatus. In a case where the calculation speed of the CPU is variable, the threshold value should be changed in accordance with the change of speed.

The threshold value may also be changed in accordance with the maximum storage capacity of the developed bitmap storage area. For instance, when the storage capacity is large, a low threshold value is set to increase the opportunity to store the developed bitmap data, whereas when the storage capacity is small, a high threshold value is set to decrease the opportunity to store the developed bitmap data.

In step S604, it is determined whether or not the object is an already-stored object. More specifically, it is determined whether or not the object read in step S601 has already been stored in the developed bitmap storage area. Assuming that the target object is an object combining a circle and a rectangle, the following data is searched in the storage area:

x1 y1 moveto

x2 y1 lineto

x2 y2 lineto

x1 y2 lineto

stroke

x2 y1 r angle1 angle2 Arc

stroke

If the target object is found as a result of the search, it is not necessary to store the target object. Therefore, the control proceeds to step S606. If the target object is not found, the control proceeds to step S605, where the developed bitmap data is compressed and stored in the developed bitmap storage area. More specifically, the object developed in the virtual screen memory in step S602 is carved out in the circumscribed rectangle, then the data in the memory is written in the compression buffer as it is and compressed by a widely used JPEG compression method or the like, and the developed bitmap data and vector graphic data thereof are stored in the developed bitmap storage area of the RAM 206.

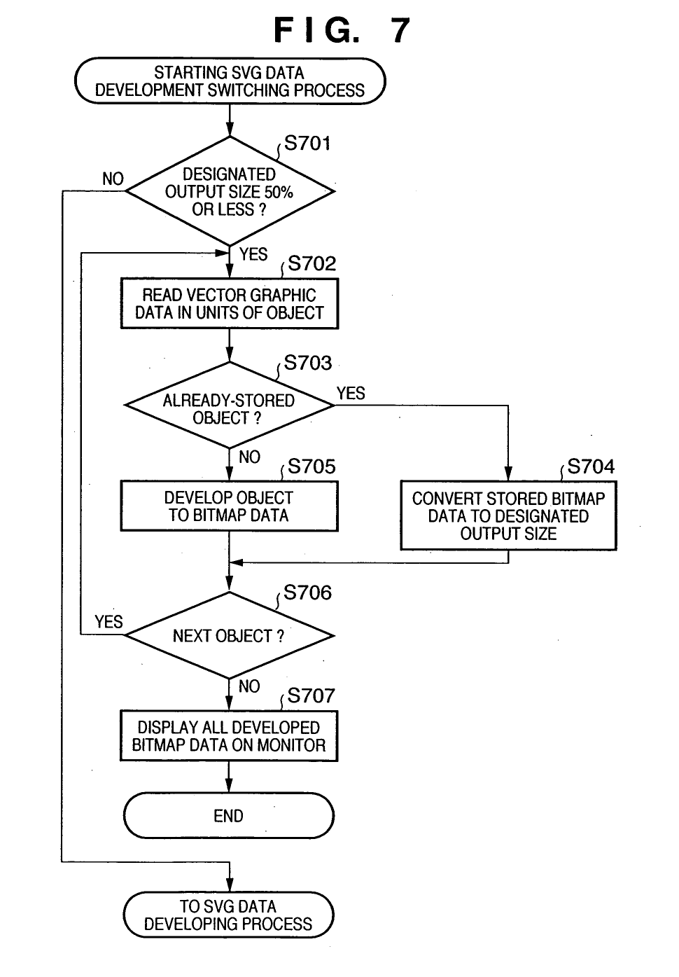

The bitmap data stored herein will be used when an output size of 50% or less is designated in the process which will be described later with reference to FIG. 7. By reducing the bitmap data to 50% in size at the time of storing the data, the memory size of the developed bitmap storage area can be reduced.

In step S606, it is determined whether or not there is a next object in the file. If there is an object to be processed in the file, the control returns to step S601 to perform processing for the next object. If there is no object in the file, the control proceeds to step S607 where all the developed bitmap data is displayed on the monitor. More specifically, all the bitmap data of the objects developed in the virtual screen memory in step S602 is transferred to the actual screen memory of the image display unit 202, and an image is displayed on the monitor of the portable information technology device 101.

The working area used in the above process is released. The SVG graphic data file which was opened to read the SVG data is closed, and the SVG data developing process ends.

Next, a description is provided on the switching process of the SVG data developing method according to the present embodiment. This process corresponds to the data development switching process 301 and bitmap reduction process 305 shown in FIG. 3.

FIG. 7 is a flowchart showing a SVG data development switching process. In step S701, the working area to be used for the SVG data development switching process is initialized, and a designated output size is checked. Herein, if the designated size is large, the object data is unconditionally developed to bitmap data. Therefore, the control proceeds to the aforementioned SVG data developing process shown in FIG. 6, and this control ends. If the designated size is small, the control proceeds to step S702 where the SVG data developing method is switched in units of object. Although this embodiment sets the switching threshold value to 50%, if the display has a high resolution, it is better to set a low threshold value, e.g., 40%. If the display has a low resolution or if a user does not require a high quality output, the threshold value may be changed to a higher value, e.g., 60%. In a case where it is determined that the switching processing is not to be performed, the aforementioned normal bitmap developing process shown in FIG. 6 is performed.

In step S702, the vector graphic data file is read in units of object. Since this processing is the same as the processing in step S601 in FIG. 6, a detailed description thereof is omitted.

In step S703, it is determined whether or not the read object has been stored in the developed bitmap storage area of the RAM 206. If the object has been stored, the control proceeds to step S704, whereas if the object has not been stored, the control proceeds to step S705. The determination processing is the same as the processing in step S604. If the object has not been stored, the normal bitmap developing process is performed from the vector graphic data file. If the object has been stored, the stored bitmap data is used for displaying a bitmap image.

In step S704, the stored bitmap data is converted to a designated output size. More specifically, the developed bitmap data, which has been JPEG-compressed and stored in the developed bitmap storage area of the RAM 206 in step S605 in FIG. 6, is decompressed. In a case where the designated size is 50%, the data is thinned out every other pixel, thereby generating bitmap data reduced to 50% in size. With respect to this reduction processing, a conventional algorithm is adopted.

In step S705, bitmap development is performed on the object. Since this processing is the same as the processing in step S602 in FIG. 6, a detailed description thereof is omitted. Assuming that a designated size is 50%, a bitmap image having a 50% size of the vector image is developed in the virtual screen memory.

In step S706, it is determined whether or not there is a next object to be processed in the read vector graphic data file. If there is a next object in the file, the control returns to step S702 where the object is read and the above-described processing is repeated. If there is no object to be processed in the file, the control proceeds to step S707 as processing for all the objects is completed.

In step S707, all the developed bitmap data is displayed on the monitor. More specifically, all the bitmap data developed in step S705 and the bitmap data reduced and developed in step S704 are transferred to the actual screen memory of the image display unit 202, and an image is displayed on the monitor of the portable information technology device 101.

The working area used in the above process is released. The SVG graphic data file which was opened to read the SVG data is closed, and the SVG data development switching process ends.

As has been described above, to display a large image on the image display unit of the portable information technology device 101 incorporating an application program for SVG graphic data, accurate calculation is performed on vector image data to develop a bitmap image, thereby displaying an accurate image. If the vector image data subjected to displaying is a complicated image, a bitmap image of the vector image data is stored so that it can be used in the next opportunity, e.g., for displaying a small image such as an image list or the like by performing reduction conversion on the stored image. As a result, it is possible to cut down the calculation time required for developing a bitmap image from a complicated vector image. Therefore, high speed image list displaying can be realized.

Note although the present embodiment has described a still image as an example, the present invention is not limited to this, but is applicable to an animation-image-display application program for moving and displaying vector image data.

### MODIFIED EXAMPLE

As mentioned in the foregoing embodiment, in the SVG developed bitmap storage determination process 303, the complication level of vector graphic data is determined to decide whether or not to store the developed bitmap data. The processing time for developing vector graphic data does not vary as long as the CPU and system designs are unchanged. However, if the CPU performance becomes twice as fast like current personal computers, naturally the development processing time varies. If the variation were simple, the development processing time could be calculated by multiplying a coefficient. However, the development processing time is complicated. Also, the variation of the system performance is not constant, e.g., the speed of some calculations increases, but the speed of other calculations does not change.

In view of the above, the modified example of the present invention further comprises a process for timing the development processing at the time of developing SVG data, and a process for comparing the bitmap development processing time with bitmap reduction processing time, thereby utilizing them for determining the actual SVG data development processing time. According to this modification, the invention realizes a system adaptable to variations even when a CPU of the portable information technology device is changed and the calculation performance is improved.

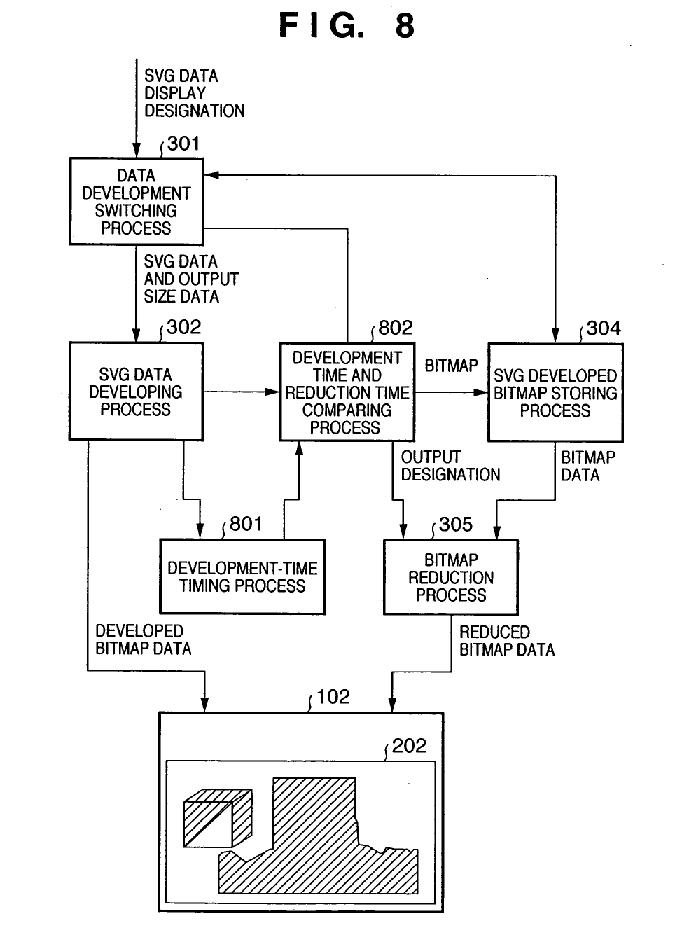

FIG. 8 shows a flow of the process according to the modified example. The bitmap data storage determining process 303 shown in FIG. 3 is changed to a development time and reduction time comparing process 802, and a development-time timing process 801 is newly added in FIG. 8. In FIG. 8, for the processes that are the same as the processes in FIG. 3, the same reference numerals are assigned, and detailed descriptions thereof are omitted.

In the development-time timing process 801 in FIG. 8, the actual processing time required for developing vector graphic data to bitmap data is timed. In this process, a real time clock is recorded at the time of starting and ending the vector graphic data development in units of object, and the processing time is obtained by calculating a difference between the recorded time.

In the development time and reduction time comparing process 802, the processing time for developing vector graphic data to bitmap data is compared with the processing time for reducing the developed bitmap data, and it is determined whether or not the bitmap data is to be stored. The bitmap development processing time is obtained by the development-time timing process 801. The bitmap reduction time is obtained based on the processing time which was stored the last time the reduction conversion processing is performed. By multiplying the obtained processing time by a coefficient corresponding to the size of the bitmap data, the bitmap reduction time can be obtained.

Next described is the SVG data development processing and the calculation processing of predicted bitmap conversion time according to the modified example.

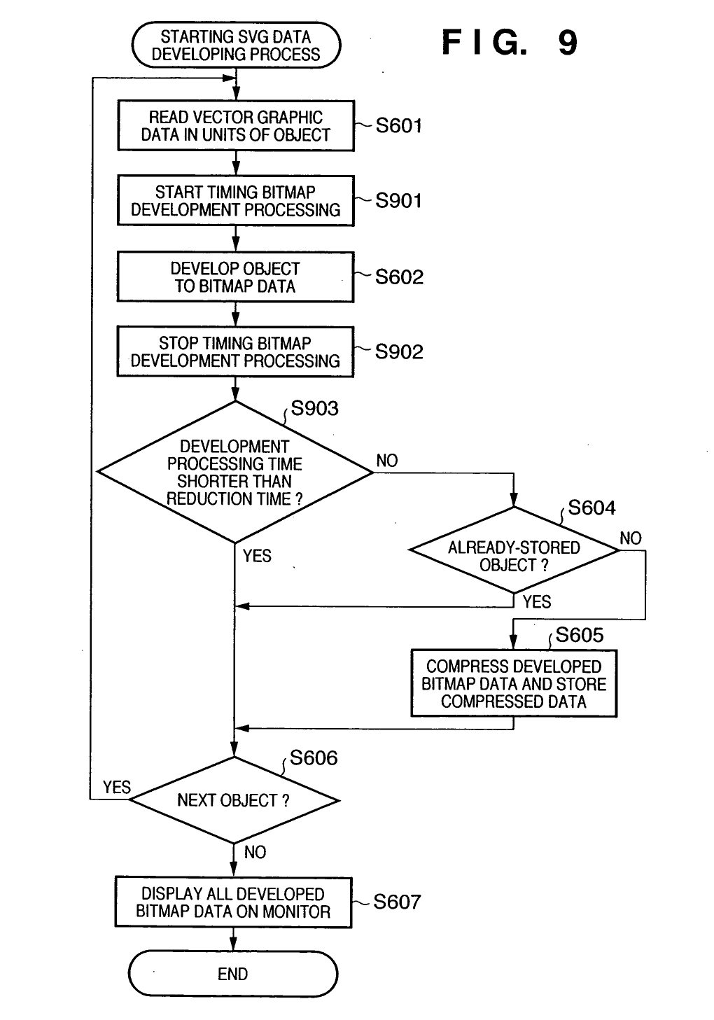

FIG. 9 is a flowchart showing a SVG data developing process according to the modified example. With respect to the same steps as those of FIG. 6, the same step numbers are assigned and detailed descriptions thereof are omitted. Since the SVG data development switching process is the same as the process described in FIG. 7, a detailed description thereof is omitted.

In step S601, vector graphic data developing is started, and vector graphic data is read in units of object. Since this process is the same as that shown in FIG. 6, a detailed description thereof is omitted.

In step S901, timing of the bitmap development processing is started. More specifically, a widely used clock chip is connected to the system bus 211 shown in FIG. 2, and the CPU 205 performs setting and reading of the time. When the bitmap development processing is started for a target object, the time of the clock chip is read and stored.

In step S602, the read object is developed to a bitmap image. Since this process is the same as that shown in FIG. 6, a detailed description thereof is omitted. In the modified example, for instance, developing the symbol 502 shown in FIG. 5 takes three seconds. Upon completion of the bitmap developing, the control proceeds to step S902, and timing of the bitmap development processing is terminated. The CPU 205 reads the time of the clock chip at this stage and calculates a difference between the read time and the time stored in step S901. If the process in step S602 takes, e.g., three seconds, the elapsed time of three seconds is obtained.

Herein, an example is given on a case where the CPU processing speed of the portable information technology device 101 in FIG. 1, which is driven by AC power, is doubled from the CPU processing speed of the device 101 driven by batteries. For instance, assuming that the CPU processing speed of the device 101 driven by AC power is double-speed of the case of being driven by batteries and the development processing time for an object is 4 seconds, when the device 101 is driven by batteries, the development processing time for the object is eight seconds.

The foregoing processing in steps S901 and S902 realizes the development-time timing process 801 in FIG. 8.

In step S903, the development processing time obtained in step S902 is compared with the reduction processing time of the bitmap data developed in step S602. If the development processing time is shorter than the reduction processing time, the control proceeds to step S606 as the bitmap data is not to be stored. If the reduction processing time is shorter than the development processing time, the control proceeds to step S604 for storing the bitmap data. Note that the bitmap development processing time is obtained in steps S901 to S902. The bitmap reduction processing time is obtained based on the processing time stored in the previous reduction processing. In reality, the processing time somewhat varies depending on the size of the bitmap data, but the difference is almost negligible. If there is a large difference, the data is multiplied by a coefficient depending on the size of the data so as to obtain the processing time.

When a CPU clock of the system is variable, the bitmap reduction processing time naturally varies. The processing performed in such case is now described. If the CPU clock does not change dynamically, this processing is unnecessary.

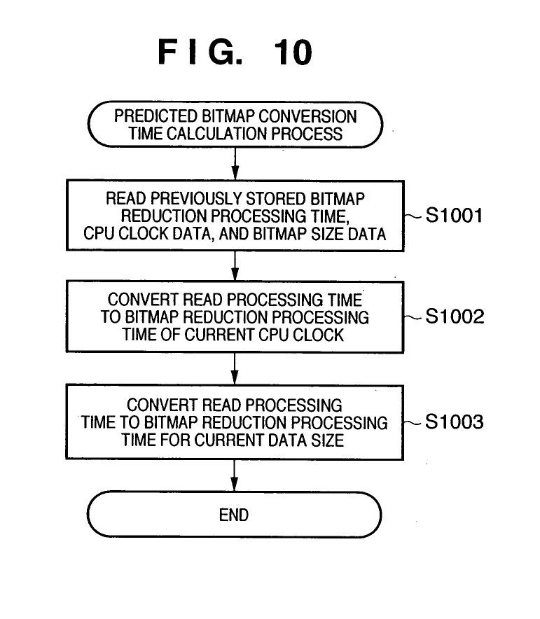

FIG. 10 is a flowchart showing a calculation process of predicted bitmap conversion time.

In step S1001, a working area to be used for calculating the bitmap conversion time is initialized, then the previously stored bitmap reduction processing time, CPU clock data at the time, and bitmap size data are read. If the CPU clock is variable, data stored in a specified area of the RAM 206 is read. The data stored in the specified area of the RAM 206 is the bitmap reduction processing time, CPU clock data at the time, and bitmap size data, which have been stored when the bitmap data is converted to a designated output size in step S704.

In step S1002, the read reduction processing time is converted to bitmap reduction processing time of the current CPU clock. For instance, assume that the bitmap reduction processing time read in step S1001 is 100 ms and the CPU clock data is 33 MHz. If the current CPU clock is 66 MHz, the CPU clock is twice as fast. Therefore, in an ideal case, the processing time is predicted to be 50 ms, half the time of the stored processing time. In other words, stored processing time×stored clock/current clock=predicted processing time.

In step S1003, the read reduction processing time is converted to a bitmap reduction processing time for the current size of the bitmap data. Based on the bitmap size read in step S1001 and the current bitmap size, the bitmap reduction processing time is corrected.

predicted processing time×((current size/stored size))=processing time

For instance, 50 ms×((100 KB/50 KB))=100 ms In the foregoing manner, predicted bitmap conversion time in a variable clock can be obtained. Then, the working area is released, and this process ends.

Referring back to FIG. 9, steps S604 to S607 are the same as the processes shown in FIG. 6.

As described above, by providing the development-time timing process 801 and the development time and reduction time comparing process 802, it is possible to realize a SVG display application program which can determine whether or not to store developed bitmap data in accordance with variations in object development processing time.

The above description is provided on a case where developed bitmap data is stored at the time of developing the vector graphic data subjected to displaying for the first time. However, the program may be constructed such that developed bitmap data is stored at the time of generating vector graphic data. Furthermore, in a case where vector graphic data is generated by an external personal computer or the like and transferred to the information technology device, the vector graphic data may be developed upon reception only in a virtual screen without being subjected to displaying, and the developed bitmap data may be stored.

Although the foregoing description is provided on a case where developed bitmap data is unconditionally stored, the area for storing developed bitmap data is limited. Therefore, developed bitmap data may be unconditionally stored until the limit of the storage, and after the limit the following process may be performed.

To the developed bitmap data once used in step S704 in FIG. 7, an area for storing the number of times used is provided. Bitmap data least used is deleted from the storage to secure an area for storing newly developed bitmap data, and often-used developed bitmap data is stored.

By virtue of this configuration, often-used symbol marks, corporate logo designs and so forth can be stored as a bitmap image so that they can be displayed quickly.

Furthermore, although the above embodiments have described an example in which one SVG data file includes plural objects, one object may be treated as one SVG data file in accordance with a specification of an application program installed in the portable information technology device 101.

As has been set forth above, according to the above-described embodiment and its modified example, when vector image data is developed to bitmap data, it is determined whether or not to store developed bitmap data in accordance with a complication level of the vector image data. Once the developed bitmap data is stored, in a case a user designates to output the stored object at low resolution, the stored bitmap data of the object can be used by converting its output size. By virtue of this process, it is not necessary to perform calculation for developing the once-developed vector image data to bitmap data having low resolution. Therefore, the image output at low resolution can be realized at high speed.

Furthermore, the calculation time required for developing vector image data to bitmap data is obtained, and the obtained calculation time is compared with the predicted time for converting the developed bitmap data to an output size, then it is determined whether or not to store the developed bitmap data. By virtue of this process, it is possible to realize an image processing apparatus which can perform processing adaptable to variations in development calculation time that is caused by a change of the CPU 205 or the like.

Therefore, even in a case of using a portable information technology device having a slower CPU 205 processing time than that of a personal computer, it is possible to display a low-resolution image at high speed.

The present invention can be applied to a system constituted by a plurality of devices (e.g., host computer, interface, reader, printer) or to an apparatus comprising a single device (e.g., copying machine, facsimile machine).

Further, the object of the present invention can also be achieved by providing a recording medium storing program codes for software which realizes functions of the above-described embodiment to a computer system or apparatus, reading the program codes, by a CPU or MPU of the computer system or apparatus, from the recording medium, then executing the program.

In this case, the program codes read from the recording medium realize the functions according to the embodiment, and the recording medium storing the program codes constitutes the invention.

Further, the recording medium, such as a floppy disk (registered trademark), hard disk, an optical disk, a magneto-optical disk, CD-ROM, CD-R, a magnetic tape, a non-volatile type memory card, and ROM can be used for providing the program codes.

Furthermore, besides aforesaid functions according to the above embodiment are realized by executing the program codes which are read by a computer, the present invention includes a case where an OS (operating system) or the like working on the computer performs a part or the entire processes in accordance with designations of the program codes and realizes functions according to the above embodiment.

Furthermore, the present invention also includes a case where, after the program codes read from the recording medium are written in a function expansion card which is inserted into the computer or in a memory provided in a function expansion unit which is connected to the computer, a CPU or the like contained in the function expansion card or unit performs a part or the entire processes in accordance with designations of the program codes and realizes functions of the above embodiment.

As set forth above, according to the above-described embodiment, vector image can be rendered at high speed.

The present invention is not limited to the above embodiment and various changes and modifications can be made within the spirit and scope of the present invention. Therefore, to apprise the public of the scope of the present invention, the following claims are made.

What is claimed is:

1. An image processing method for developing a vector image to rendering data having a size, comprising:
a step of developing a vector image to rendering data;
a step of storing the rendering data, developed in said developing step, in accordance with a predetermined criterion; and
a step of converting the rendering data, stored in said storing step, to rendering data having a designated output size in accordance with reduction designation of the vector image.

2. The method according to claim 1, wherein said predetermined criterion is a complication level of the vector image, and in a case where a number of basic graphics constructing the vector image is equal to or larger than a predetermined value, the rendering data is stored in said storing step.

3. The method according to claim 1, wherein said predetermined criterion is a complication level of the vector image, and in a case where a number of commands for rendering the vector image is equal to or larger than a predetermined value or in a case where rendering time of the command is equal to or longer than predetermined time, the rendering data is stored in said storing step.

4. The method according to claim 1, wherein said predetermined criterion is processing time, and in a case where time required for developing the vector image to rendering data in said developing step is longer than time required for converting the rendering data to a designated output size in said converting step, the rendering data is stored in said storing step.

5. The method according to claim 4, wherein said processing time is predicted processing time that varies in accordance with processing speed of a CPU which executes the process.

6. The method according to claim 1, wherein in said storing step, the rendering data is compressed and stored, and in said converting step, the compressed rendering data is decompressed and converted to the designated output size.

7. The method according to claim 1, further comprising a step of displaying the rendering data in a display unit.

8. An image processing apparatus for developing a vector image to rendering data having a designated output size and outputting the rendering data, comprising:
a developing unit for developing a vector image to rendering data;
a storage unit for storing the rendering data, developed by said developing means, in accordance with a predetermined criterion; and
wherein said developing unit converts the stored rendering data to a designated output size in accordance with reduction designation of the vector image.

9. A program causing a computer to execute respective steps of the image processing method described in claim 1.

10. A computer-readable recording medium recording the program described in claim 9.

11. An image processing apparatus for developing a vector image to rendering data having a designated output size and outputting the rendering data, comprising:
developing means for developing a vector image to rendering data;
storage means for storing the rendering data, developed by said developing means, in accordance with a predetermined criterion; and
converting means for converting the stored rendering data to a designated output size in accordance with reduction designation of the vector image.
